(19) United States
(12) Patent Application Publication
(10) Pub. No.: US 2026/0068820 A1
(43) Pub. Date: Mar. 12, 2026

(54) REVERSIBLE DRIVE CUTTER MODULE

(71) Applicant: CNH Industrial America LLC, New Holland, PA (US)

(72) Inventors: Kevin HANSON, New Holland, PA (US); Jon MCKINNIS, JR., New Holland, PA (US); Kevin CORDES, New Holland, PA (US)

(21) Appl. No.: 18/830,298

(22) Filed: Sep. 10, 2024

(51) Int. Cl. A01D 69/06; A01D 34/66

(52) U.S. Cl. CPC A01D 69/06; A01D 34/66

(57) ABSTRACT

Reversible cutter module and method for reconfiguring. The cutter module has a cutter rotation assembly including a cutter gear (e.g., a top cap gear) driving a rotatable cutter (e.g., cutter disc and knives) and a drive assembly. The drive assembly includes a double bevel gear slidably repositionable on a drive shaft such that a first bevel engages the cutter gear when in the first position on the drive shaft and a second bevel engages the cutter gear when in the second position on the drive shaft. Rotation of the drive shaft with the double bevel gear in the first position rotates the cutter gear in a rotation direction and rotation of the shaft in the same direction with the double bevel gear in the second position rotates the cutter gear in an opposite rotation direction.

### FIELD OF THE INVENTION

The present invention relates to agricultural systems and, more specifically, to a reversible drive cutter module for use in an agricultural mowing assembly.

### BACKGROUND OF THE INVENTION

A farmer may use an agricultural system including an agricultural mowing assembly, such as a mower or mower conditioner, in a field to cut crop material like hay or grass and deposit the cut crop material onto the field in windrows or swaths. Typically, the mowing system includes an agricultural driving vehicle, such as a tractor, and an agricultural mowing assembly towed behind the agricultural driving vehicle or integrated into a header coupled to the agricultural driving vehicle. For cutting large fields, the mowing systems may include an agricultural driving vehicle that pushes an agricultural mowing assembly in front of the agricultural driving vehicle, while simultaneously pulling another agricultural mowing assembly behind the agricultural driving vehicle.

A conventional agricultural mowing assembly often includes a cutterbar with multiple cutter modules linearly spaced along the width of the cutterbar, which may be separated by spacer modules. Each cutter module includes a drive assembly for driving a cutter rotation assembly. Each cutter rotation assembly includes a cutter drive gear that may be coupled to a cutter disc having knives pivotally mounted on the periphery of the cutter disc. The drive assembly drives the cutter rotation assembly which, in turn, causes the cutter disc to rotate. Rotation of the cutter disc causes the knives to pivot outward due to centrifugal force and sever standing crop from the ground through an impact action. An example cutterbar is described in U.S. Pat. No. 5,937,624 to McLean et al., which is incorporated fully herein by reference.

Each cutter module is configured to rotate the cutter disc in a particular direction as a drive shaft within the drive assembly is rotated. Adjacent cutter modules that rotate the cutter disc in the same direction are referred to as co-rotating cutter modules. Adjacent cutter modules that rotate the cutter modules in opposite directions, on the other hand, are referred to as counter-rotating cutter modules. Whether the cutter modules are co-rotating or counter-rotating affects the cutting characteristics and the mat of cut crop existing the mower or mower conditioner. A farmer may therefore want to change the configuration of one or more cutter modules based on crop conditions, personal preferences, or both.

### BRIEF SUMMARY OF THE INVENTION

In one example, an agricultural mowing assembly is provided. The agricultural mowing assembly includes a cutterbar and cutter modules coupled to the cutterbar. Each cutter module includes a cutter rotation assembly including a cutter gear configured to drive a rotatable cutter and a drive assembly coupled to the cutter rotation assembly. The drive assembly is configured to drive the cutter gear of the cutter rotation assembly. The drive assembly of at least one cutter module includes a drive shaft and a double bevel gear having a first bevel and a second bevel. The double bevel gear is slidably repositionable on the drive shaft between a first position and a second position where the shaft and double bevel gear are positioned such that the first bevel engages the cutter gear when the double bevel gear is in the first position on the drive shaft and the second bevel engages the cutter gear when the double bevel gear is in the second position on the drive shaft. Rotation of the drive shaft in a shaft rotation direction with the double bevel gear in the first position rotates the cutter gear in a cutter rotation direction and rotation of the shaft in the same shaft rotation direction with the double bevel gear in the second position rotates the cutter gear in an opposite cutter rotation direction.

In another example, a cutter module for use on a cutterbar of an agricultural mowing assembly is provided. The cutter module includes a cutter rotation assembly including a cutter gear configured to drive a rotatable cutter and a drive assembly coupled to the cutter rotation assembly. The drive assembly is configured to drive the cutter gear of the cutter rotation assembly. The drive assembly of at least one cutter module includes a drive shaft and a double bevel gear having a first bevel and a second bevel. The double bevel gear is slidably repositionable on the drive shaft between a first position and a second position where the shaft and double bevel gear are positioned such that the first bevel engages the cutter gear when the double bevel gear is in the first position on the drive shaft and the second bevel engages the cutter gear when the double bevel gear is in the second position on the drive shaft. Rotation of the drive shaft in a shaft rotation direction with the double bevel gear in the first position rotates the cutter gear in a cutter rotation direction and rotation of the shaft in the same shaft rotation direction with the double bevel gear in the second position rotates the cutter gear in an opposite cutter rotation direction.

In another example a method for reconfiguring a cutter module is provided. The cutter module includes a cutter rotation assembly including a cutter gear. The cutter gear is configured to drive a rotatable cutter and a drive assembly coupled to the cutter rotation assembly. The drive assembly is configured to drive the cutter gear of the cutter rotation assembly. The drive assembly of at least one cutter module has a drive shaft and a double bevel gear having a first bevel and a second bevel. The double bevel gear is slidably repositionable on the drive shaft between a first position and a second position where the shaft and double bevel gear are positioned such that the first bevel engages the cutter gear when the double bevel gear is in the first position on the drive shaft and the second bevel engages the cutter gear when the double bevel gear is in the second position on the drive shaft. Rotation of the drive shaft in a shaft rotation direction with the double bevel gear in the first position rotates the cutter gear in a cutter rotation direction and rotation of the shaft in the same shaft rotation direction with the double bevel gear in the second position rotates the cutter gear in an opposite cutter rotation direction. This example method includes unfixing the double bevel gear from the drive shaft while the double bevel gear is in the first position on the drive shaft, sliding the double bevel gear from the first position on the drive shaft to the second position on the drive shaft while the double bevel gear is unfixed, and fixing the double bevel gear to the drive shaft in the second position on the drive shaft after sliding the double bevel gear from the first position to the second position.

### BRIEF DESCRIPTION OF THE SEVERAL VIEWS OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a side view of an exemplary embodiment of a mowing system in accordance with the present disclosure;

FIG. 2 is an enlarged top plan view of a modular cutterbar for use in the mowing system of FIG. 1;

FIG. 3 is a top plan view of a spacer module forming a part of the modular cutterbar shown in FIG. 2;

FIG. 4 is a top plan view of a cutter module forming a part of the modular cutterbar shown in FIG. 2;

FIG. 5A is a cross-sectional view of the cutter module of FIG. 4 depicting the relationship of the drive mechanism therein, a splined drive shaft with a repositionable double bevel gear thereon shown in FIG. 5B to demonstrate the difference between the clockwise and counterclockwise drive mechanism for the cutter modules due to repositioning of the double bevel gear on the splined drive shaft;

FIG. 6A is an enlarged elevational view of the splined drive shaft with the double bevel gear in a first position forming a part of the drive mechanism of the cutter module shown in FIG. 5A;

FIG. 6B is a cross-sectional view of the double bevel gear taken along lines 6B-6B of FIG. 6A with the drive shaft omitted to depict the internally splined hub of the double bevel gear configured to mate with the splined drive shaft;

FIG. 7 is an exploded view of the drive assembly and the cutter rotation assembly of the cutter module of FIG. 5A; and

FIG. 8 is a flowchart depicting a method for reversing the rotation direction of the cutter module of FIG. 5A by repositioning the double bevel gear on the drive shaft.

### DETAILED DESCRIPTION OF THE INVENTION

The terms “forward”, “rearward”, “left” and “right”, when used in connection with the agricultural system described herein and/or components thereof are usually determined with reference to the direction of forward operative travel of the agricultural driving vehicle, but they should not be construed as limiting.

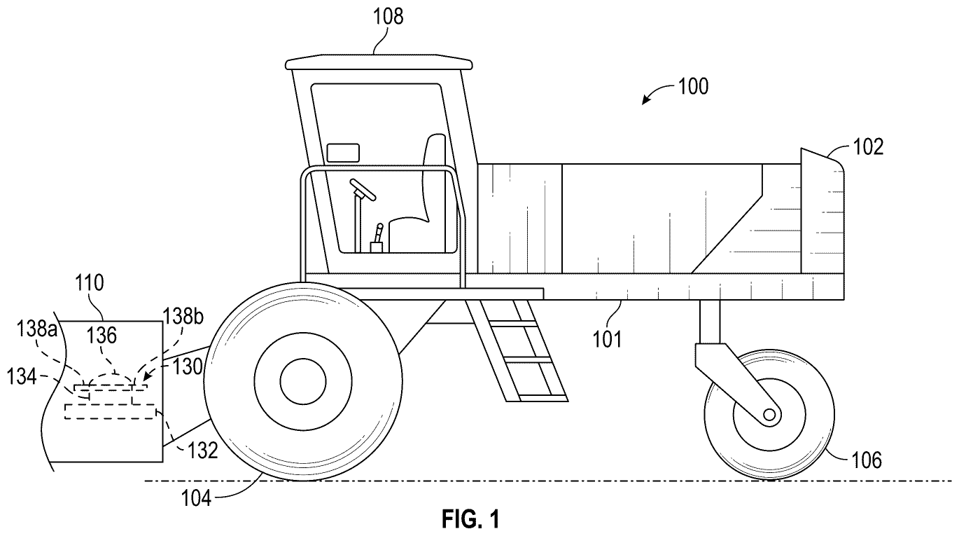

Referring now to the drawings, FIG. 1 depicts an agricultural system 100 that includes an agricultural driving vehicle 102 and an agricultural mowing assembly 110. The agricultural mowing assembly is driven by the agricultural driving vehicle 102 in a forward direction of travel (toward the left in the illustrated view of FIG. 1). The agricultural driving vehicle 102 generally includes a chassis 101, front wheels 104, back wheels 106, and a cab 108 for housing the operator. The agricultural driving vehicle 102 can be a separate vehicle (as illustrated) in the form of any desired agricultural vehicle, such as a tractor, coupled to the agricultural mowing assembly 110 or may be integrated into the agricultural mowing assembly 110, e.g., as a self-propelled mower.

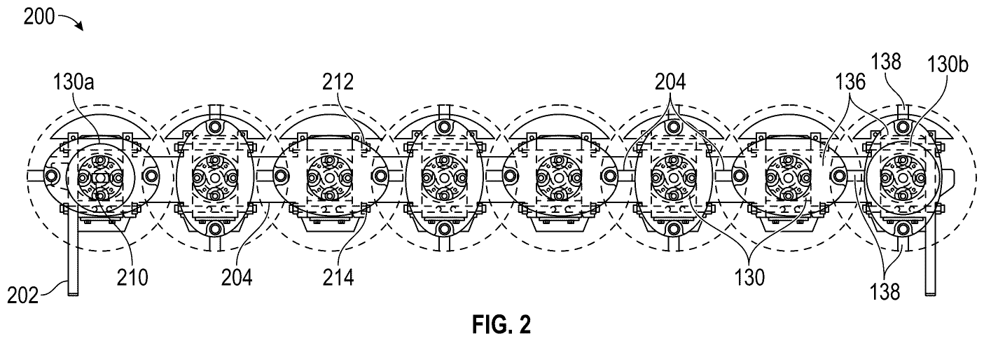

The agricultural mowing assembly 110 includes a cutterbar 200 (FIG. 2) supporting multiple cutter modules 130 separated by spacer modules 204 (FIG. 2). Each cutter module 130 includes a drive assembly 132 and a cutter rotation assembly 134 coupled to the drive assembly 132. In the illustrated example, the cutter rotation assembly 134 supports a cutter disc 136, which has a pair of knives 138a and 138b rotatably coupled thereto. In operation, the drive assembly 132 drives the cutter rotation assembly 134, which causes the cutter disc 136 to rotate and the knives 138a and 138b to extend. The extended knives 138a and 138b cut crop material upon impact as the cutter disc 136 rotates.

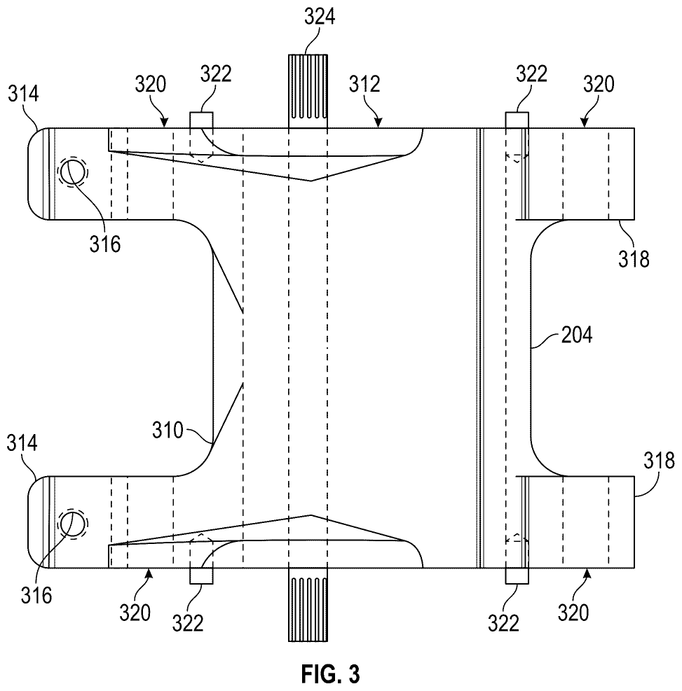

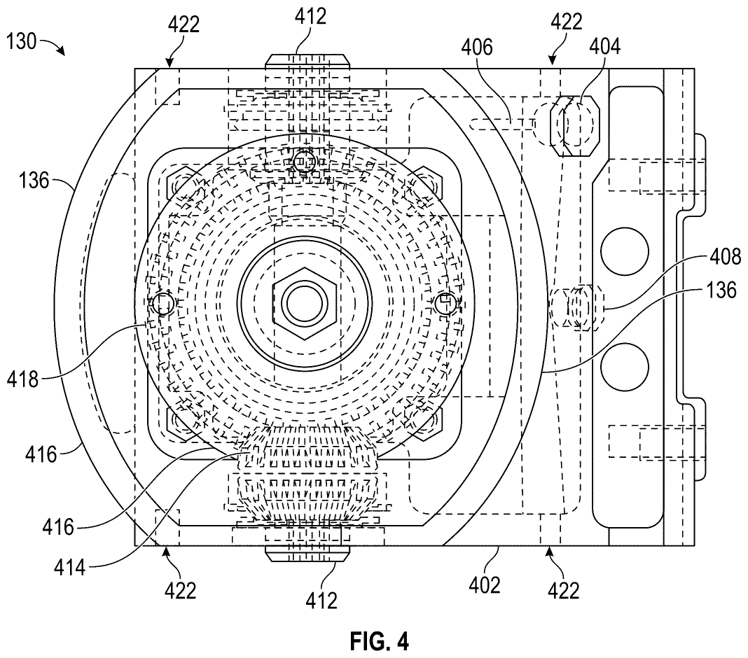

FIG. 2 depicts an example of a cutterbar 200 for use in the agricultural mowing assembly 110, FIG. 3 depicts a spacer module 204 of the cutterbar 200, and FIGS. 4, 5, 6A, 6B, and 7 depict a cutter module 130 of the cutterbar 200. The illustrated cutterbar 200 is a modular cutterbar that includes eight (8) cutter modules 130 separated by seven (7) spacer modules 204, although more or fewer cutter modules 130 and spacer modules 204 may be present depending on the implementation. The spacer modules 204 and the cutter modules 130 may be interconnected by conventional fasteners 212/214. The illustrated cutterbar 200 in the agricultural mowing assembly 110 is supported by a frame 202 at both the left and right remote ends of the cutterbar 200. Other types of cutterbars and other types of support structures for use with the developments described herein would be understood by one of skill in the art from the description herein and are considered within the scope of the present disclosure.

The cutter module 130 includes a drive shaft assembly 412 (FIG. 4), the spacer module 204 (FIG. 3), and a transfer shaft 324 (FIG. 3) that extends though the spacer module 204 for interconnecting the drive shaft assemblies 412 of adjacent cutter modules 130. Thus, in operation, the drive shaft assemblies 412 of all cutter modules 130 are interconnected and turn in the same direction. For example, when the drive shaft assembly 412 of one cutter module (e.g., a cutter module 130a on one end of the cutterbar 200) is turning in a particular direction, the drive shaft assemblies 412 of all other cutter modules (including a cutter module 130b on an opposite end of the cutterbar 200) will also turn in that same direction.

In one example, rotational power is delivered to a cutter module 130 of the cutterbar 200 on an end of the cutterbar 200 (e.g., the first cutter module 130a by a power input shaft 210 that directly drives a first cutter disc 136 from above). In other examples, rotational power may be delivered to an inboard/interior cutter module 130. Rotational power delivered to a cutter module 130 is then transferred to the drive assembly 132 from a driven gear 418 (FIG. 4) to the double bevel gear 414 and then transferred to the remainder of the cutter modules 130 as described above.

The spacer module 204 can best be seen in FIG. 3. The spacer module 204 is formed as a cast housing 310 having a transverse passageway 312 extending therethrough to allow for the passage of the transfer shaft 324 and to keep the weight of the spacer module 204 to a minimum. The housing 310 is formed with a pair of forwardly extending mounting arms 314 and a corresponding pair of rearwardly extending mounting arms 318, each arm 314, 318 being formed with a transverse opening 320 extending therethrough. Each of the forward mounting arms 314 is also formed with a vertical hole 316 near the tip of the corresponding mounting arm to permit the mounting of, for example, rock guards for the cutter modules 130. Each of the opposing, generally vertical sides of the spacer modules 204 are provided with a pair of dowel pins 322 positioned for corresponding engagement with the dowel recessions 422 (FIG. 4) in the cutter modules 130 to properly position the cutter modules 130 and spacer modules 204 with respect to one another. Other types of spacer modules and/or apparatus for interconnecting the cutter modules 130 will be understood by one of skill in the art from the description herein and are considered within the scope of the present disclosure.

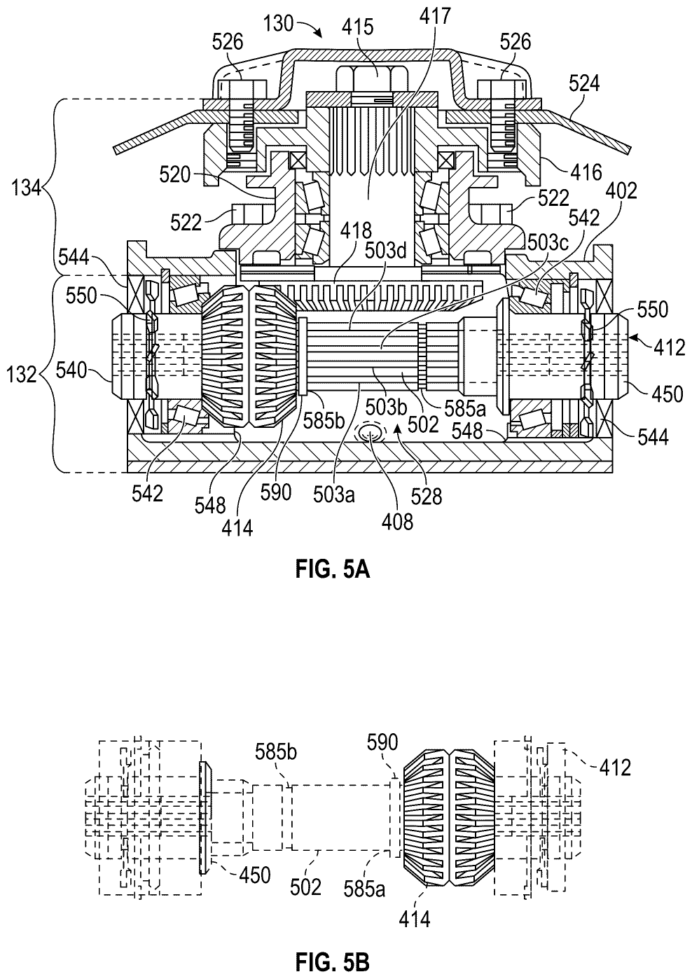

The cutter module 130 can best be seen in FIGS. 4, 5, 6A, 6B, and 7. The cutter module includes the drive assembly 132 and the cutter rotation assembly 134. The drive assembly 132 includes a hollow cast housing 402 supporting and containing a drive shaft assembly 412. The drive shaft assembly 412 includes a drive shaft 502 (see FIG. 5A) and a double bevel gear 414 repositionable mounted on the drive shaft 502 (see FIG. 5B) to change the direction of cutter disc 136 rotation with respect to drive shaft 502 rotation.

The double bevel gear 414 has a first bevel on one side and a second bevel on the other side. The first bevel has a first angle with respect to a longitudinal/rotational axis of the drive shaft 502 and the second bevel has a second angle with respect to the longitudinal axis of the drive shaft 502 that is equal and opposite to the first angle.

The double bevel gear 414 is slidably repositionable on the drive shaft 502 in two operational states. In a first state, the double bevel gear 414 is positioned on the drive shaft 502 such that the first bevel engages a driven gear 418 (e.g., a cutter gear) adjacent a perimeter edge of a cap 520. In a second state, the double bevel gear 414 is positioned on the drive shaft 502 such that the second bevel engages the driven gear 418 adjacent an opposite perimeter edge of a cap 520. This arrangement results in, responsive to the drive shaft 502 rotating in the same direction, the double bevel gear 414 driving the driven gear 418 in a first direction (e.g., clockwise) when the double bevel gear 414 is in the first position and in a second direction (e.g., counter-clockwise) when the double bevel gear 414 is in the second position.

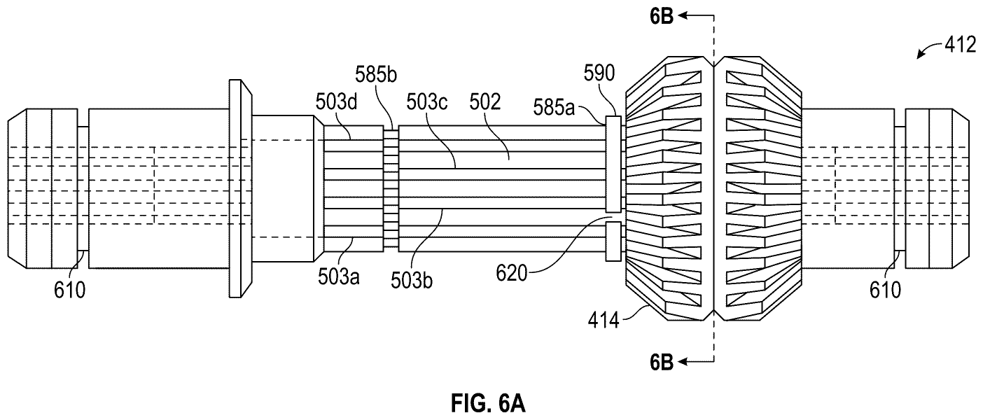

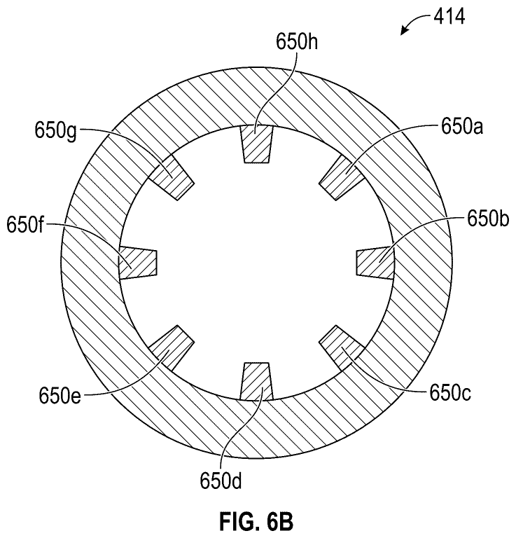

In an example, the drive shaft 502 is a splined shaft containing grooves 503 (such as illustrate grooves 503a, b, c, d) spaced around the perimeter of the drive shaft 502 parallel to the axis of rotation. In accordance with this example, the double bevel gear 414 is internally splined to mate with the splined shaft as shown in FIG. 6B. As illustrated in FIG. 6B, the double bevel gear 414 includes projections 650a-f for mating with corresponding grooves 503 of the splined shaft 502. Although eight (8) projections 650 and corresponding grooves 503 are illustrated, essentially any number of projections and grooves may be employed (including many more smaller projections/splines) to enable axial movement of the double bevel gear 414 along the rotational axis of the splined shaft 502, while preventing rotational movement around the rotational axis of the splined shaft 502.

The double bevel gear 414 may be fixed in the first position as illustrated in FIG. 5B and FIG. 6A using a retaining system comprising a groove 585a in the drive shaft 502 and a retaining ring 590, which functions as a removable shoulder, positioned in the groove 585a. The groove 585a is adjacent the first position and prevents movement of the double bevel gear to the left when the retaining ring 590 is positioned in the groove 585a. To unfix the double bevel gear 414, the retaining ring 590 is removed from the groove 585a. In the illustrated example, the retaining ring 590 includes a gap 620 to enable removal of the retaining ring 590 from the groove 585a to unfix the double bevel gear 414. The retaining ring 590 may additionally include ears (not shown) to facilitate removal (e.g., with pliers). Once unfixed, the double bevel gear 414 may move (e.g., slid) to the left into the second position. The double bevel gear 414 may then be fixed in the second position by inserting the retaining ring 590 into the groove 585b as illustrated in FIG. 5A. The groove 585b is adjacent the second position and prevents movement of the double bevel gear 414 to the right when the retaining ring 590 is positioned in the groove 585b. Other types of retaining systems will be understood by one of skill in the art from the description herein and are considered within the scope of the present disclosure.

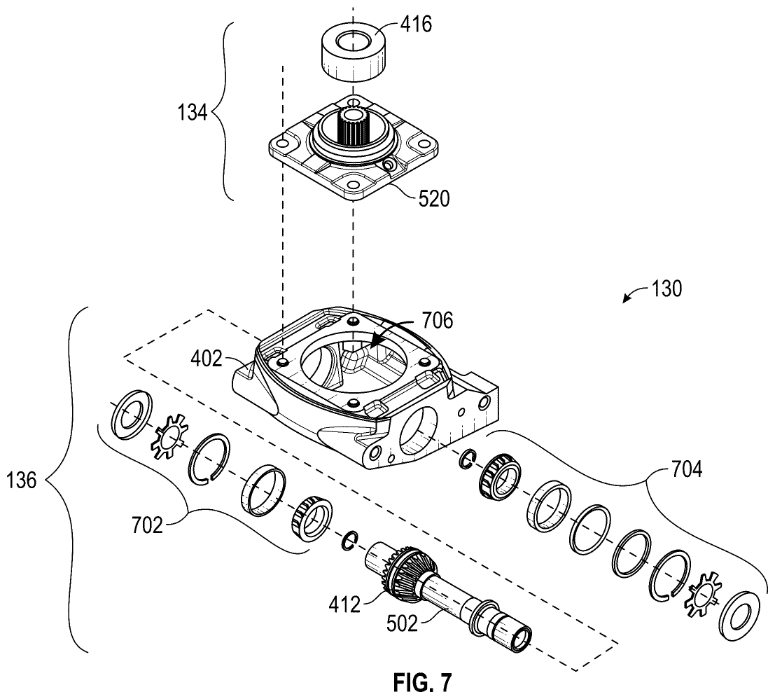

The cutter rotation assembly 134 includes a hollow cast cap 520 supporting a driven gear 418 (e.g., the cutter gear) having an integral shaft 417 that is coupled to the cutter disc 136, e.g., via a bushing/disc hub 416. In the illustrated example, a bolt 415 clamps the disc hub 416 to the integral shaft 417 attached to the driven gear 418 and the bolts 526 couple the disc 524 to the disc hub 416. The housing 402 includes an opening 706 (FIG. 7) sized and shaped to accommodate the driven gear 418 when the cap 520 is placed on the housing 402 and to permit access to the double bevel gear 414 and drive shaft 502 when the cap 520 is removed from the housing 402. The cap 520 may be fixed to the housing 402 by conventional fasteners such as four (4) bolts 522 and may be unfixed and removed from the housing by undoing the fasteners such as by removing the four (4) bolts 522.

Each cutter module 130 is provided with an oil plug 404 that seals off an opening into the oil reservoir 528 through which lubricating oil can be introduced into the reservoir 528. The oil plug 404 is provided with an integral dip stick 406 that extends into the oil reservoir 528 so that the oil level within the reservoir 528 can be measured. Each cutter module 130 is also provided with a drain plug 408 sealing off a corresponding opening at the bottom of the oil reservoir 528 through which the lubricating oil within the reservoir 528 can be selectively drained by gravity. A pressure relief valve (not shown) is also provided in the cap 520 to allow for any release of pressure within the reservoir 528 above a pre-determined operating level.

The generally vertical sides of the housing 402 are formed with dowel recessions 422 to engage with dowel pins 322 inserted within corresponding recessions in the spacer module to secure the proper spatial relationship between the spacer module 204 and the cutter module 130 during assembly into the cutterbar 200.

Each cutter disc 136 is somewhat oval in shape and is provided with a cutting knife 138 pivotally mounted at the opposing ends of the major axis of the cutter disc 136, e.g., by a bolt. When operating at normal rotational speeds (e.g., 2200 revolutions per minute), the knives 138a, b extend radially due to centrifugal force for cutting crop material.

Each of the cutter modules 130 is clamped between the adjacent spacer modules 204 by forward fasteners 212 and rearward fasteners 214 extending through the openings 320 in the mounting arms 314, 318 immediately next to the cutter module 130. The inter-engagement of the dowel pins 322 and the dowel recessions 422 position each spacer module 204 properly with respect to the cutter module 130.

The drive assembly 132 includes additional components for securing the drive shaft 502 within the housing 402 and enabling smooth rotation of the drive shaft therein. These additional components include a first hardware set 702 positioned on one end of the drive shaft 502 and a second hardware set 704 positioned on the other end of the drive shaft 502. Each of the hardware sets 702, 704 include retaining hardware, retaining seals, and one or more bearings.

A disc hub 416 is detachably splined onto a driven shaft 417 having an integral driven gear 418 positioned within the oil reservoir 528. A disc member 524 is detachably connected to the disc hub 416 by bolts/fasteners 526 so as to be rotatable therewith. The driven shaft 417 is rotatably supported by the cap 520, which is detachably mounted to the cutter module housing 402 by fasteners 522. The cap 520 seals the opening 706 in the top of the housing 402 through which the driven gear 418 can be extracted from the oil reservoir 528.

The driven gear 418 is drivingly engaged with the double bevel gear 414 forming part of a drive shaft assembly 412 extending transversely through the cutter module 130 beneath the driven gear 418. The drive shaft assembly 412 has a modular construction and is formed from a central drive shaft 502 that is splined at each opposing end thereof, a drive transfer hub 450 that is engaged with one splined end of the drive shaft 502 and another drive transfer hub 540 which is splined on the opposing splined end of the drive shaft 502.

The drive shaft assembly 412 is rotatably supported within the oil reservoir 528 by a pair of opposing tapered roller bearings 542 positioned with the cone apex of the bearing being oriented outwardly and associated seals 544 operable to seal the opening extending transversely through the cutter module housing 402 at the opposing sides thereof. The rotating tapered bearing rollers pump oil away from the cone apex side of the bearing which causes all of the lubricating oil outside of the bearing to be pumped toward the inner portion of the cutter module reservoir 528.

In order to move lubricating oil into the seal area, a groove 548 is cast into the housing 402 within the cutter module 130 beneath the respective bearings 542. The grooves 548 permit lubricating oil to flow from the oil reservoir 528, past the bearings 542 and into the area near the seals 544. The action of the rollers in the tapered bearing 542 pumps the oil back into the oil reservoir 528. To disperse the oil to the seals 544, each end of the drive shaft assembly 412 is provided with an oil slinger 550. The oil slinger 550 is positioned on the respective hub 450, 540 of the drive shaft assembly 412 in close proximity to the corresponding seal (not shown). The oil slinger 550 is split and clamps into a groove 610 machined into both drive transfer hubs 450 and 540 in the same manner as a conventional external bearing retaining ring.

The transfer shaft 324 is splined at each opposing end thereof to be drivingly received within either of the hubs 450, 540 to transfer rotational power thereto. In assembling a disc cutterbar 200, the cutter modules 130 are clamped between adjacent spacer modules 204 by clamping fasteners and the drive line is connected by coupling the transfer shafts 324 between the exposed hubs 450, 540 in the adjacent cutter modules 130. One skilled in the art will realize that both of the hubs 450, 540 are splined through an interior passageway so as to be able to receive both the drive shaft 502 in one side thereof and the transfer shaft 324 in the other side thereof.

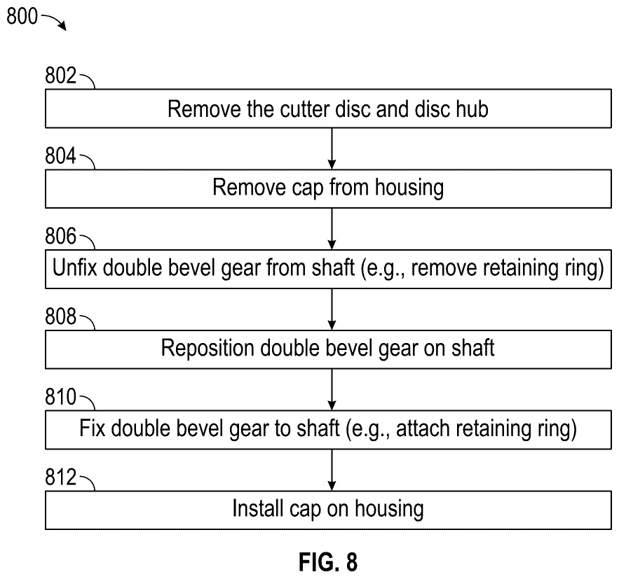

FIG. 8 depicts a flowchart 800 of example steps for reversing the disc rotation direction of a cutter module. To facilitate description, the steps of flowchart 800 are described with reference to the cutter module 130 depicted in FIG. 5A. Other suitable cutter modules for carrying out the steps of flowchart 800 will be understood by one of skill in the art from the description herein. In some examples, one or more steps of the flowchart 800 may be omitted, performed in an order other than the order depicted in FIG. 8, or both without departing from the scope of the present disclosure.

At block 802, a user removes the cutter disc 524 and disc hub 416. In an example, the user removes the cutter disc and disc hub 416 by removing the fasteners (e.g., bolts 526 and bolt 415) securing the disc 524 to the disc hub 416 and securing the disc hub 416 to the integral shaft 417 attached to the driven gear 418.

At block 804, a user removes a cap 520 from the housing 402. The cap 520 covers an opening 706 in the housing 402 and removing the cap 520 provides access to components within the housing 402, such as the double bevel gear 414 and retaining mechanisms for securing the double bevel gear 414 in either a first position or a second position on the drive shaft 502. In an example, the cap 520 is secured to the housing 402 with four bolts 522 and the user can remove the cap 520 from the housing 402 by undoing the four bolts and lifting the cap from the housing to gain access to the double bevel gear 414 and retaining mechanism 590.

At block 806, the user unfixes the double bevel gear 414 from the drive shaft 502. In an example, the double bevel gear 414 is initially in a first position on the drive shaft 502 such as depicted in FIG. 6A (e.g., corresponding to a clockwise rotation of the cutting disc 136) and is fixed in the first position on the drive shaft 502 by a retaining mechanism such as a retaining ring 590 positioned in a retaining groove 585a within the drive shaft 502 adjacent the first position on the drive shaft 502. In accordance with this example, the user unfixes the double bevel gear 414 from the drive shaft 502 by removing the retaining ring 590 from the retaining groove 585a—freeing the double bevel gear 414 to move on the drive shaft 502.

At block 808, the user repositions the double bevel gear 414 on the drive shaft 502. In an example, the user slides the double bevel gear 414 on the drive shaft 502 from the first position to a second position of the drive shaft 502 such as depicted in FIG. 5A (e.g., corresponding to a counter-clockwise rotation of the cutting disc 136). The drive shaft 502 may be a splined drive shaft and the double bevel gear may be internally splined to mate with the splined drive shaft to prevent rotation of the double bevel gear 414 on the drive shaft 502 while allowing the double bevel gear 414 to move in an axial direction along the splined drive shaft 502 between the first and second position.

At block 810, the user fixes the double bevel gear 414 to the drive shaft 502. In an example, the drive shaft 502 includes a retaining groove 585b adjacent the second position on the drive shaft 502 (see FIG. 4). In accordance with this example, the user fixes the double bevel gear 414 to the drive shaft 502 in the second position by attaching a retaining ring 590 (e.g., the retaining ring removed at block 804) to the retaining groove 585b adjacent the second position on the drive shaft 502—fixing the double bevel gear 414 in the second position on the drive shaft 502.

At block 812, the user installs the cap 520 on the housing 402. The cap 520 is configured to cover the opening 706 in the housing 402 and installing the cap 520 covers the opening 706 to prevent access to components within the housing 402. In an example where the cap 520 is secured to the housing 402 with four bolts 522, the user can install the cap 520 on the housing 402 by positioning the cap 520 over the housing and securing the cap 520 to the housing by tightening the four bolts 522.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein but is intended to include all changes and modifications that are within the scope and spirit of the invention.

What is claimed is:

1. An agricultural mowing assembly comprising:
a cutterbar; and
a plurality of cutter modules coupled to the cutterbar, each cutter module comprising:
a cutter rotation assembly including a cutter gear configured to drive a rotatable cutter; and
a drive assembly coupled to the cutter rotation assembly, the drive assembly configured to drive the cutter gear of the cutter rotation assembly, the drive assembly of at least one cutter module comprising:
a drive shaft; and
a double bevel gear having a first bevel and a second bevel, the double bevel gear slidably repositionable on the drive shaft between a first position and a second position, the shaft and double bevel gear positioned such that the first bevel engages the cutter gear when the double bevel gear is in the first position on the drive shaft and the second bevel engages the cutter gear when the double bevel gear is in the second position on the drive shaft;
wherein rotation of the drive shaft in a shaft rotation direction with the double bevel gear in the first position rotates the cutter gear in a cutter rotation direction and rotation of the shaft in the same shaft rotation direction with the double bevel gear in the second position rotates the cutter gear in an opposite cutter rotation direction.

2. The agricultural mowing assembly of claim 1, wherein the at least one cutter module comprises two of the plurality of cutter modules, wherein the drive shafts of the two cutter modules are interconnected, and wherein the agricultural mowing assembly further comprises:
a spacer module positioned on the cutterbar between the two cutter modules;
a transfer shaft extending through the spacer module;
wherein the transfer shaft interconnects the drive shafts of the two cutter modules.

3. The agricultural mowing assembly of claim 1, wherein the at least one cutter module further comprises:
a housing through which the drive shaft passes, the housing having an opening adjacent a central portion of the drive shaft that enables movement of the double bevel gear between the first and second position.

4. The agricultural mowing assembly of claim 3, wherein the at least one cutter module further comprises:
a cap supporting the cutter gear, the cap removably coupled to the housing and configured to cover the opening;
wherein removal of the cap enables access to the double bevel gear for repositioning the double bevel gear between the first position and the second position.

5. The agricultural mowing assembly of claim 4, wherein the first bevel engages the cutter gear adjacent a perimeter edge of the cap when the double bevel gear is in the first position, the second bevel engages the cutter gear adjacent an opposite perimeter edge of the cap when the double bevel gear is in the second position, and the cap is positioned above the opening when the at least one cutter module is coupled to the cutterbar and the cutterbar is in an operational state.

6. The agricultural mowing assembly of claim 1, wherein the drive shaft is a splined shaft including grooves, the double bevel gear includes internally splined hub configured to mate with the splined shaft, and the internally splined hub of the double bevel gear slides within the grooves of the splined shaft to reposition the double bevel gear between the first position and the second position.

7. The agricultural mowing assembly of claim 6, wherein the drive shaft further comprises a retaining groove adjacent each of the first position and the second position and wherein the agricultural mowing assembly further comprises:
a retaining ring sized to engage the retaining grooves, the retaining ring repositionable and sized such that;
when the retaining ring is positioned in the retaining groove adjacent the first position when the double bevel gear is in the first position the double bevel gear is prevented from moving away from the first position on the drive shaft; and
when the retaining ring is positioned in the retaining groove adjacent the second position when the double bevel gear is in the second position the double bevel gear is prevented from moving away from the second position on the drive shaft.

8. The agricultural mowing assembly of claim 1, wherein the first bevel has a first angle with respect to a longitudinal axis of the drive shaft and the second bevel has a second angle with respect to the longitudinal axis of the drive shaft that is equal and opposite the first angle.

9. An agricultural system comprising:
the agricultural mowing assembly of claim 1; and
an agricultural driving vehicle coupled to the agricultural mowing assembly.

10. A cutter module for use on a cutterbar of an agricultural mowing assembly, the cutter module comprising:
a cutter rotation assembly including a cutter gear configured to drive a rotatable cutter; and
a drive assembly coupled to the cutter rotation assembly, the drive assembly configured to drive the cutter gear of the cutter rotation assembly, the drive assembly of at least one cutter module comprising:
a drive shaft; and
a double bevel gear having a first bevel and a second bevel, the double bevel gear slidably repositionable on the drive shaft between a first position and a second position, the shaft and double bevel gear positioned such that the first bevel engages the cutter gear when the double bevel gear is in the first position on the drive shaft and the second bevel engages the cutter gear when the double bevel gear is in the second position on the drive shaft;
wherein rotation of the drive shaft in a shaft rotation direction with the double bevel gear in the first position rotates the cutter gear in a cutter rotation direction and rotation of the shaft in the same shaft rotation direction with the double bevel gear in the second position rotates the cutter gear in an opposite cutter rotation direction.

11. The cutter module of claim 10, further comprising:
a housing through which the drive shaft passes, the housing having an opening adjacent a central portion of the drive shaft that enables movement of the double bevel gear between the first and second position.

12. The cutter module of claim 11, wherein the at least one cutter module further comprises:
a cap supporting the cutter gear, the cap removably coupled to the housing and configured to cover the opening;
wherein removal of the cap enables access to the double bevel gear for repositioning the double bevel gear between the first position and the second position.

13. The cutter module of claim 12, wherein the first bevel engages the cutter gear adjacent a perimeter edge of the cap when the double bevel gear is in the first position, the second bevel engages the cutter gear adjacent an opposite perimeter edge of the cap when the double bevel gear is in the second position, and the cap is positioned above the opening when the at least one cutter module is coupled to the cutterbar and the cutterbar is in an operational state.

14. The cutter module of claim 10, wherein the drive shaft is a splined shaft including grooves, the double bevel gear includes an internally splined hub configured to mate with the splined shaft, and the internally splined hub of the double bevel gear slides within the grooves of the splined shaft to reposition the double bevel gear between the first position and the second position.

15. The cutter module of claim 14, wherein the drive shaft further comprises a retaining groove adjacent each of the first position and the second position and wherein the cutter module further comprises:
a retaining ring sized to engage the retaining grooves, the retaining ring repositionable and sized such that;
when the retaining ring is positioned in the retaining groove adjacent the first position when the double bevel gear is in the first position the double bevel gear is prevented from moving away from the first position on the drive shaft; and
when the retaining ring is positioned in the retaining groove adjacent the second position when the double bevel gear is in the second position the double bevel gear is prevented from moving away from the second position on the drive shaft.

16. The cutter module of claim 10, wherein the first bevel has a first angle with respect to a longitudinal axis of the drive shaft and the second bevel has a second angle with respect to the longitudinal axis of the drive shaft that is equal and opposite the first angle.

17. A method for reconfiguring a cutter module having a cutter rotation assembly including a cutter gear configured to drive a rotatable cutter and a drive assembly coupled to the cutter rotation assembly, the drive assembly configured to drive the cutter gear of the cutter rotation assembly, the drive assembly of at least one cutter module having a drive shaft and a double bevel gear having a first bevel and a second bevel, the double bevel gear slidably repositionable on the drive shaft between a first position and a second position, the shaft and double bevel gear positioned such that the first bevel engages the cutter gear when the double bevel gear is in the first position on the drive shaft and the second bevel engages the cutter gear when the double bevel gear is in the second position on the drive shaft, wherein rotation of the drive shaft in a shaft rotation direction with the double bevel gear in the first position rotates the cutter gear in a cutter rotation direction and rotation of the shaft in the same shaft rotation direction with the double bevel gear in the second position rotates the cutter gear in an opposite cutter rotation direction, the method comprising:
unfixing the double bevel gear from the drive shaft while the double bevel gear is in the first position on the drive shaft;
sliding the double bevel gear from the first position on the drive shaft to the second position on the drive shaft while the double bevel gear is unfixed; and
fixing the double bevel gear to the drive shaft in the second position on the drive shaft after sliding the double bevel gear from the first position to the second position.

18. The method of claim 17, wherein the drive shaft further includes a retaining groove adjacent each of the first position and the second position and wherein the unfixing comprises:
removing a retaining ring from the groove adjacent the first position.

19. The method of claim 18, wherein the fixing comprises:
attaching a retaining ring to the groove adjacent the second position.

20. The method of claim 17, the cutter module including a cap supporting the cutter gear and a housing through which the drive shaft passes, the housing having an opening adjacent a central portion of the drive shaft that enables movement of the double bevel gear between the first and second position, the method further comprising:
removing the cap from the housing prior to unfixing the double bevel gear from the drive shaft; and
installing the cap on the housing after fixing the double bevel gear to the drive shaft;
wherein removal of the cap enables access to the double bevel gear for repositioning the double bevel gear between the first position and the second position.
